(19) United States
(12) Patent Application Publication
(10) Pub. No.: US 2004/0155521 A1
(43) Pub. Date: Aug. 12, 2004

(54) Car brake anti-lock system

(76) Inventors: Myoung-Kil Kim, Seoul (KR); Won-Jae Song, Incheon (KR)

Correspondence Address: D. Edward Dolgorukov, Marshall & Melhorn, 8th Floor, Four SeaGate, Toledo, OH, 43604, US

(21) Appl. No.: 10/475,890

(22) PCT Filed: Apr. 25, 2002
(86) PCT No.: PCT/KR02/00765

(30) Foreign Application Priority Data
Apr. 26, 2001 (KR) 2001/22658

(51) Int. Cl. B60T 17/04

(52) U.S. Cl. 303/87

(57) ABSTRACT

The present invention discloses A car brake anti-lock system to prevent any locking phenomenon from taking place in the brake by installing the car brake anti-lock system according to the present invention between the master cylinder for supplying the hydraulic pressure of the car brake and the cylinder pipe, reserving some of the hydraulic pressure to be transmitted to the car wheel when the car brake is put on, and supplying it continuously with discontinuity. More particularly, the present invention is to enable the car brake anti-lock system to be installed in any car, irrespective of whether a car is small or large, by providing a supporting boss, a piston wing and a piston shaft in one block, which is moved up and down by an expansion stroke and a return stroke thereof depending upon any supplied hydraulic pressure, improving the durability of the supporting boss and the piston shaft by using a metal material therefore, transmitting the brake pressure in three-stage flexible response to any change in the brake pressure by installing rubber buffer rings, small disk springs and large disk springs in a cylindrical guide bush, and installing a pressure regulating valve, which is freely adjustable, in the lower end of the lower body.

### TECHNICAL FIELD

The present invention relates to a car brake anti-lock system to prevent any locking phenomenon from taking place in the brake by installing the car brake anti-lock system between the master cylinder for supplying the hydraulic pressure of the car brake and the cylinder pipe, reserving some of the hydraulic pressure to be transmitted to the car wheel when the car brake is put on, and supplying it continuously with discontinuity. More particularly, the present invention relates to a car brake anti-lock system to enable the car brake anti-lock system to be installed in any car, irrespective of whether a car is small or large, by providing a supporting boss, a piston wing and a piston shaft in one block, which is moved up and down by an expansion stroke and a return stroke thereof depending upon any supplied hydraulic pressure, improving the durability of the supporting boss and the piston shaft by using a metal material therefore, transmitting the brake pressure in three-stage flexible response to any change in the brake pressure by installing rubber buffer rings, small disk springs and large disk springs in a cylindrical guide bush, and installing a pressure regulating valve, which is freely adjustable, in the lower end of the lower body.

### BACKGROUND ART

The car hydraulic pressure brake anti-lock system is to prevent any locking phenomenon from taking place in the brake by installing it between the master cylinder for supplying the hydraulic pressure of the car brake and the cylinder pipe, reserving some of the hydraulic pressure to be transmitted to the car wheel when the car brake is put on, and supplying it continuously with discontinuity.

Various kinds of such car brake anti-lock systems are disclosed to the public. Particularly, in the car brake anti-lock system as disclosed in the Korean Utility Model Publication No. 95-6675, as shown in FIG. 1, the upper body 1 in which a hole (H), through which the brake hydraulic pressure is transmitted, is formed is combined with the lower body 2 by mating the screw portion of the upper body with that of the lower body, the elastic bulb 3 of rubber material is inserted between the said upper body 1 and the lower body 2, the retaining tube 11 having a Teflon coating layer formed on its internal side is inserted into the vertical groove 10 in the said elastic bulb, the expansion portion 3″ of the elastic bulb 3 is inserted into the retaining tube 11, a plural number of concatenated disk springs 12 are inserted between the expansion portion 3″ of the elastic bulb 3 and the bottom of the said retaining tube 11, thereby getting to be compressed and decompressed by expansion and contraction of the elastic bulb to provide the repulsive force for divisional supply of the hydraulic pressure, and a pair of annular pieces 14, 14″ having the annular sill 15 for limiting the extent of compressing the said disk springs 12 formed in the central part thereof are respectively positioned over and under the said disk springs 12 so that when any excessive hydraulic pressure is supplied, any of the springs may be prevented from being damaged.

Action of the said conventional car brake anti-lock system is hereunder described.

When the brake pedal is stepped on for braking, the brake hydraulic pressure gets to apply the brake directly to the car wheel through the T-shape connector installed between the master cylinder and the cylinder pipe and the cylinder pipe, and some of the hydraulic pressure gets to be supplied to the upper body 1 through the channel connected with the connector and further supplied to the hydraulic pressure guiding groove 3′ formed in the elastic bulb 3. When the hydraulic pressure is supplied to the hydraulic pressure-guiding groove 3′ formed in the elastic bulb 3, the expansion portion 3″ of the elastic bulb 3 gets to be expanded by the hydraulic pressure. Meanwhile, since the outer circumferential side of the said expansion portion 3″ is in tight contact with the retaining tube 11, the volume of the said expansion portion cannot be expanded in the horizontal direction and therefore, it gets to be expanded only downward. When the expansion portion 3″ of the elastic bulb 3 is expanded downward, the upper annular piece 14 gets to be pushed down and in turn the springs 12 get to be compressed. As a result, some of the hydraulic pressure gets to be reserved therein and further any locking phenomenon is prevented from taking place in the brake.

When the hydraulic pressure transmitted to the car wheel by operation of the brake gets to fall below the pressure being applied to the springs 12, some of the reserved hydraulic pressure gets to be supplied to the car wheel to reinforce the brake force until the hydraulic pressure transmitted to the car wheel gets to be equal to the hydraulic pressure of the said expansion portion. Usually, this operation gets to be repeated several times to several tens times per second.

However, the conventional car brake anti-lock system has the following demerits.

First of all, since the springs get to be directly compressed and decompressed by expansion and contraction of the elastic bulb itself, the elastic bulb of the rubber material gets to be overworked.

Further, when the elastic bulb is expanded, friction takes place between the elastic bulb and the retaining tube of a metal material to cause any damage to the expansion portion of the elastic bulb of the rubber material. As a result, the hydraulic pressure gets to leak to the lower end of the retaining tube to bring about any accident.

Also, the Teflon coating layer formed in the internal side of the retaining tube gets to fall off by its repetitive contacts with the expansion portion of the elastic bulb that gets to be repetitively expanded and contracted, and further when such fallen Teflon coating pieces get in between springs, the anti-lock system fails to work normally.

Also, since the springs are installed in one group, the range of reserving the brake hydraulic pressure is narrow, and when the springs compressed by expansion of the elastic bulb return to the original stage elastically, the range of the pressure to be supplied divisionally has no flexibility.

Also, since the elastic force of the expansion portion of the elastic bulb has the same force at all times, it is difficult to apply the said conventional system to a large car requiring a large brake hydraulic pressure. Therefore, a separate brake anti-lock system has to be designed for large cars.

### DISCLOSURE OF THE INVENTION

The present invention is created to improve the said demerits, and its objective is to provide a car brake anti-lock system that can be installed in all cars, irrespective of whether a car is small or large, by providing a supporting boss, a piston wing and a piston shaft in one block, which is moved up and down in response to the pressure transmitted by operation of the brake, improving the durability of the supporting boss and the piston shaft to the greatest extent by using a metal material therefore, having the one block supported by 3 stages depending upon any change in the internal pressure in the guide bush so that the one block may respond flexibly to any change in the brake pressure, and enabling the internal pressure in the guide bush to be freely adjusted.

In order to accomplish the said objective, the car brake anti-lock system according to The present invention is constructed of an upper body having a connector joint hole for transmission of the brake pressure formed therein and further having a screw portion formed in the lower inner circumferential end thereof; a lower body which is tightly combined with the upper body in the upper end thereof by mating the screw portion formed in the upper outer circumferential end thereof with that of the upper body; and a cylindrical guide bush inserted into the vertical groove formed in the inner circumferential side of the lower body. Wherein, a supporting boss of a metal material in response to the pressure transmitted by operation of the brake is more tightly combined with a piston wing through which a screw shaft of the supporting boss is inserted by mating the screw shaft of the supporting boss tightly with a fastening nut. Further, a piston shaft is combined with the screw shaft of the supporting boss which is combined with the piston wing with the piston wing protruding beyond the outer circumference of the supporting boss, by mating the screw portion of the piston shaft with the said screw shaft. And the cylindrical guide bush supports the protrusive portion of the piston wing, and in such cylindrical guide bush, a plural number of large disk springs and a plural number of small disk springs are provided vertically, and further a pair of large guide rings and a pair of small guide rings are provided respectively under the large disk springs and the small disk springs for keeping the pressure balance, and also, a large buffer ring and a small buffer ring are provided respectively between the large guide rings and between the small guide rings in order to response to any minute pressure, and a pressure regulating valve is combined with the lower end of the lower body by mating its screw portion with that of the lower body so that the lower end of the piston shaft may extend therein.

### BRIEF DESCRIPTION OF THE DRAWINGS

The invention is illustrated in the accompanying drawings, in which the Figures are diagrammatic, partial views of devices of the invention; in particular,

FIG. 1 is a sectional view showing the conventional car brake anti-lock system of the prior art.

FIG. 2 is a sectional view showing the car brake anti-lock system according to the present invention.

FIG. 3 is an exploded perspective view of the car brake anti-lock system according to the present invention.

FIG. 4a is a sectional view showing the operation condition of the main portion in an embodiment of the car brake anti-lock system according to the present invention.

FIG. 4b is a sectional view showing the operation condition of the main portion in another embodiment of the car brake anti-lock system according to the present invention.

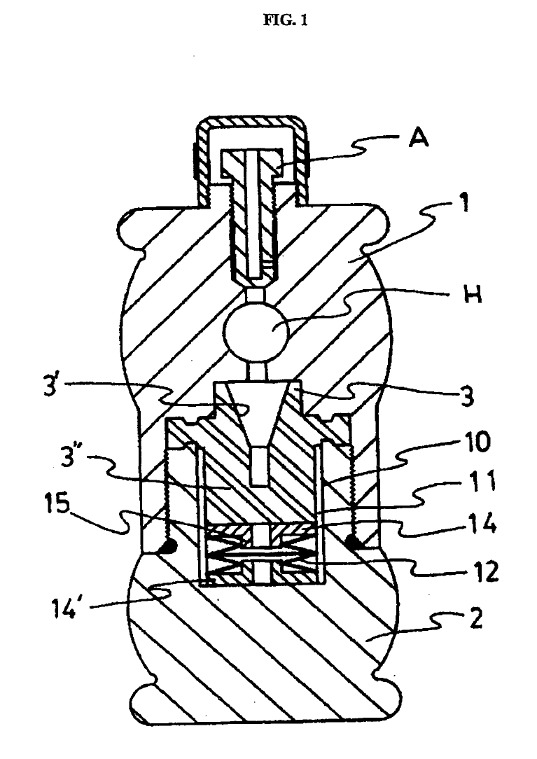

### BEST MODE FOR CARRYING OUT THE INVENTION

The preferred embodiment of the invention is described in detail, referring to the attached drawings.

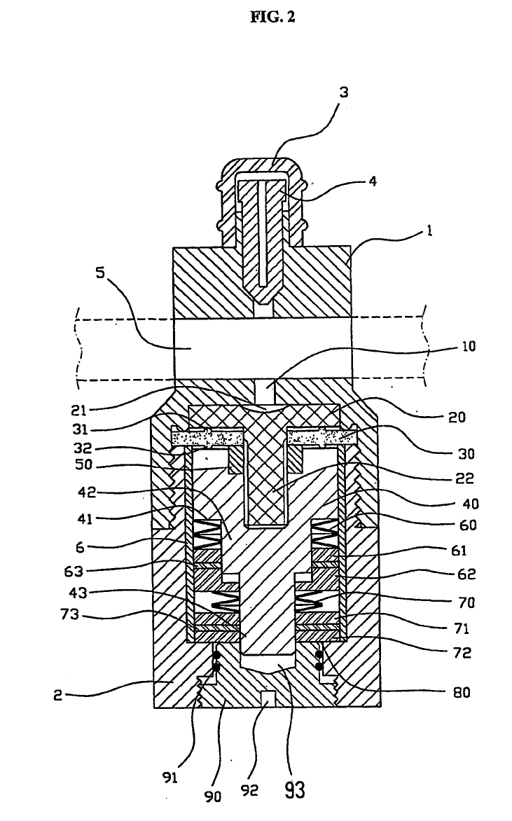

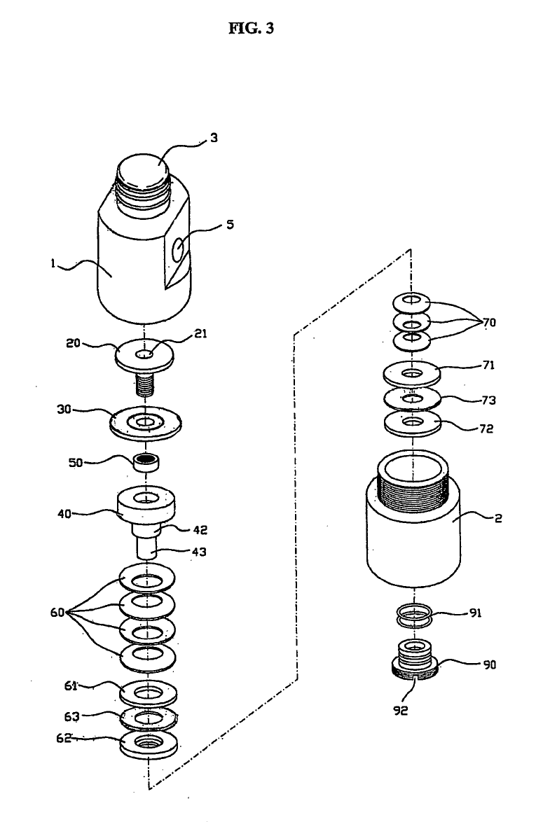

As illustrated in FIGS. 2 and 3, the present invention is constructed of; the upper body 1 having the air valve 4 which is tightly covered up with the valve cap 3 for preventing any deterioration of the braking capability due to any air taking place in the oil pipe in the upper end thereof and having the connect joint hole 5 which is open horizontally and the oil inlet 10 connected perpendicularly with the connector joint hole 5 formed in the central part and further the screw portion for combination with the lower body 2 formed in the lower inner circumferential end thereof; and the lower body 2 which is combined respectively with the upper body in the upper end thereof and the pressure regulating valve in the lower end thereof by mating each screw portion in the upper end and the lower end thereof respectively with that of the upper body and that of the pressure regulating valve. Wherein the pressure-regulating valve has a pair of O-rings 91 for enhancing the tightening performance of the screw portion, having the regulating groove formed in the lower end thereof so that the combination depth of the said valve with the lower body may be adjusted.

Wherein, the supporting boss 2 having the guiding groove 21 formed in the central upper end thereof and further the screw shaft 22 with the screw thread on its outer circumferential surface formed in the central lower end thereof is provided under the said oil inlet 10, and so, the upper end of the supporting boss 20 gets to be in tight contact with the internal upper side of the upper body 1 by mating the fastening nut 50 tightly with the screw shaft 22. Meanwhile, the piston wing 30 having a hole through which the screw shaft 22 is to be inserted is positioned around the screw shaft 22 between the supporting boss 20 and the fastening nut 50, protruding beyond the outer circumference of the supporting boss 20 and having the upper prominence 31 and the lower prominence 32, which are symmetrically positioned, formed respectively in the upper side and the lower side thereof. Also, the piston shaft 40, which is in contact with the lower prominence 32 of the said piston wing 30, being combined with the screw shaft 22, is provided, and further the fastening nut 50 having a screw thread formed in the internal side thereof is provided with it being in tight contact with the inner circumferential groove in the upper end of the piston shaft 40 and in combination with the screw shaft 22.

Wherein, the screw shaft 22 of the supporting boss 20 is more tightly combined with the piston shaft 40 by the fastening nut 50 with it being vertically inserted through the piston wing 30 of the rubber material, and so the tightness and the fastening force thereof gets to be enhanced. Meanwhile, the supporting boss 20 and the piston shaft 40 are made of the metal material, and so, their durability does not get to be deteriorated even under any change in the pressure according to operation of the brake and any high pressure.

The supporting bed for large disk springs 41 is provided around the middle portion of the said piston shaft 40, and the large diametrical boss 42 and the small diametrical boss 43 are provided in the central portion of the supporting bed for large disk springs 41 with them being of respective given heights so that a fault side may be formed in the front end of the large diametrical boss 42. And the cylindrical guide bush 6 is provided around the supporting bed for large disk springs 41 with the one end thereof supporting the piston wing 30 and the other end thereof being in tight contact with the pressure bearing plate 80 of the lower body 2.

Under the supporting bed for large disk springs 41 of the said piston shaft 40, a plural number of large disk springs 60 and a pair of large guide rings 61, 62 through which the large diametrical boss 42 gets to be inserted are provided and further the large buffer ring 63 is provided between the two large guide rings 61,62. Meanwhile, the outer diameter of the large disk spring 60 is formed so that it may not interfere with the inner circumferential side of the guide bush 6 when the spring is compressed. Further, each outer diameter of the large guide ring 61, 62 and the large buffer ring 63 is formed in the same size as or a minutely smaller size than the inner diameter of the guide bush 6, and the inner diameter thereof is formed in the same size as or a minutely larger, size than the diameter of the large diametrical boss 42. Meanwhile, it is desirable that the inner diameter of the lower large disk spring 62 is formed with a fault side being formed in a given height so that only the small diametrical boss 43 may be inserted through it and thereby any interference may be prevented between the front end of the large diametrical boss and the small disk springs 70, as shown in FIG. 2.

Also, under the front end of the large diametrical boss 42, a plural number of small disk springs 70 and a pair of small guide rings 71,72 through which the small diametrical boss 43 gets to be inserted are provided and further the small buffer ring 73 is provided between the two small guide rings 71,72. Meanwhile, it is desirable that the outer diameter of the small disk spring 70 is formed in a larger size than the outer diameter of the large diametrical boss 42 so that it may support the lower large guide ring 62, and that each outer diameter of the small guide rings 71,72 and the small buffer ring 73 is formed in the same size as or a minutely smaller size than the inner diameter of the guide bush 6, and each inner diameter thereof is formed in the same size as or a minutely larger size than the diameter of the small diametrical boss 43.

The pressure regulating valve 90, which is combined with the said lower body 2 by mating the screw portion thereof with that of the lower body, is provided so that its upper end may be in contact with the lower small guide ring 72 supported by the pressure bearing plate 80. Meanwhile, it is designed so that in case it goes higher than the pressure bearing plate 80 by screwing it up, it may support the lower small guide ring 72, and further it has the guiding groove 93 formed in the upper end thereof so that it may not interfere with the front end of the small diametrical boss 43 of the piston shaft 40 which is moved up and down by the action of the hydraulic pressure and the elastic force.

The action of the car brake anti-lock system according to the present invention which has the said construction is hereunder described.

In the first place, the car brake anti-lock system according to the present invention is installed between the master cylinder and the cylinder pipe by using the T-shape connector. When the brake pedal is stepped on for braking, the brake hydraulic pressure gets to apply the brake directly to the car wheel through the connector and the cylinder pipe, and some of the hydraulic pressure gets to be supplied to the oil inlet 10 of the upper body 1 through the connector joint hole 5 connected with the connector and further transmitted to the guiding groove 21 of the supporting boss 20.

When the brake hydraulic pressure is transmitted to the guiding groove 21, the hydraulic pressure causes the supporting boss 20 of the metal material to fall. Wherein, the supporting boss 20, the piston wing 30 and the piston shaft 40 get to fall at the same time since they are assembled into one block. Meanwhile, the piston wing 30 gets to prevent any oil from leaking to the interface between the supporting boss 20 and the upper body 1 due to any high pressure, and prominences 31, 32 formed respectively in the upper side and the lower side of the piston wing 30 and the fastening nut 50 can prevent any oil from leaking to the interface between the supporting boss 20 and the piston shaft 40 and the fastening portion of the screw shaft 22.

With any oil leakage being perfectly prevented as above described, when the piston shaft 40 combined with the supporting boss 20, the piston wing 30 and the fastening nut 50 in one block gets to fall, the pressure gets to be transmitted to the large disk springs 60 in contact with the supporting bed for large disk springs 41 and further in turn, transmitted to the large guide ring 61, the large buffer ring 63 and the large guide ring 62, and further in turn, transmitted to the small disk springs 70, the small guide ring 71, the small buffer ring 73 and the small guide ring 72. As a result, some of the hydraulic pressure gets to be reserved in the guide bush 6.

In this action, first, the element having the smallest force to bear the pressure starts being compressed. That is to say, firstly, the large buffer ring 63 and the small buffer ring 73 of the rubber material are compressed, and further when the transmitted pressure gets to be greater, the small disk springs 70 are compressed, and further when the transmitted pressure gets to be much greater, the large disk springs 60 are compressed. Wherein, each pair of large guide rings 61,62 and the small guide rings 71,72 can keep the pressure balance so that the pressure may be evenly transmitted to the whole face of each spring when each spring 60,70 is elastically transformed.

This construction is provided so that the car brake anti-lock system may be in flexible response to any change in the pressure according to any change in operation of the brake, enabling some of the hydraulic pressure to be reserved in response to any pressure in an extensive pressure range from a minute pressure to a high pressure. On the other hand, when the brake hydraulic pressure transmitted to the car wheel by operation of the brake gets to fall below the force applied to the compressed buffer ring 63,73 or each spring 60, 70, some of the reserved hydraulic pressure gets to be supplied to the car wheel until the hydraulic pressure transmitted to the car wheel and the internal hydraulic pressure in the guide bush 6 get to be equal each other, and as a result, the braking force gets to be reinforced.

Other embodiments of the said car brake anti-lock system according to the present invention in which the pressure-regulating valve 90 is freely adjusted are hereunder described.

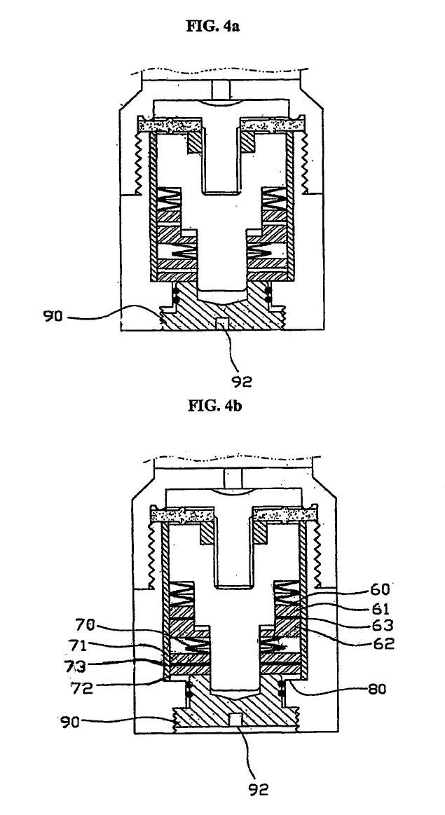

FIG. 4a shows the operation condition of one embodiment according to the present invention. FIG. 4a shows the condition that the pressure regulating valve 90 just functions for close up. This is the condition that the lower small guide ring 72 is supported by the pressure bearing plate 80, which is just the condition as above described.

FIG. 4b shows the condition that the upper end of the pressure regulating valve 90 has gone higher than the pressure bearing plate by increasing the fastening depth, using the adjusting groove 92; that is to say, the condition that the lower small guide ring 72 is supported by the upper end of the pressure regulating valve 90. This represents the condition that if the pressure regulating valve 90 is let to go higher from the lower body 2, the upper end of the pressure regulating valve 90 goes higher even under the condition that the brake hydraulic pressure is not transmitted, and thereby, the lower small guide ring 72 is let to go higher. Wherein, the same effect that the pressure by operation of the brake gets to be transmitted from the oil inlet 10 takes place in the guide bush 6, and so, starting from the large buffer ring 63 and the small buffer ring 73, which are the elements having the smallest force to bear the pressure, compression takes place.

This is a condition that a minute pressure or any greater pressure (in case the pressure regulating valve 90 has gone much higher) exists at all times in the guide bush 6. So, in case any hydraulic pressure by operation of the brake is transmitted into the guide bush under this condition, each disk spring 60,70 gets to respond more sensitively and rapidly, enabling The present invention to be applied as the brake anti-lock system for large cars.

Industrial Applicability

As above described, in the car brake anti-lock system according to The present invention a supporting boss, a piston wing and a piston shaft are provided in one block, which is moved up and down in response to the pressure transmitted by operation of the brake, and the durability of the supporting boss and the piston shaft is improved by using a metal material therefore to maximize the usable life thereof. And it has the elastic elements which are supported by 3 stages depending upon the strength of the pressure in the guide bush to enable it to respond to any minute change in the pressure, enabling the internal pressure in the guide bush to be freely adjusted so that it gets to be installable in any car, irrespective of whether it is small or large. Therefore, The present invention is a useful invention enabling the car brake anti-lock system to be installed in any car without any limitation to its usable extent and further produced in mass.

What is claimed is:

1. A car brake anti-lock system consisting of; the upper body having the air valve for discharging air in the upper end thereof and having the connect joint hole for transmission of the hydraulic pressure formed in the central part and further the screw portion formed in the lower inner circumferential end thereof; the lower body which is tightly combined with the upper body in the upper end thereof by mating the screw portion formed in the upper outer circumferential end thereof with the screw portion of the upper body; and the cylindrical guide bush inserted into the vertical groove formed in the inner circumferential side of the lower body, which is characterized by comprising;
the supporting boss in which the guiding groove for transmission of the brake hydraulic pressure and the screw shaft are formed;
the piston wing through which the screw shaft of the supporting boss is inserted downward, being tightly seated between the supporting boss and the guide bush by the fastening nut;
the piston shaft which is combined with the screw shaft under the piston wing by mating the screw portion thereof with that of the screw shaft and in which the supporting bed for large disk springs, the large diametrical boss and the small diametrical boss are provided;
the fastening nut which is combined with the screw shaft with it being in tight contact with the upper inner circumferential side of the piston shaft;
a plural number of large disk springs which are seated around the large diametrical boss;
a pair of guide rings which are seated around the large diametrical boss and support the large disk springs;
the large buffer ring which is seated between the two large guide rings;
a plural number of small disk springs which are seated around the small diametrical boss;
a pair of small rings which are seated around the small diametrical boss and support the small disk springs with them being supported by the pressure bearing plate;
the small buffer ring which is seated between the two small guide rings; and
the pressure regulating valve which can be moved up and down with it being combined with the lower body in the lower central part of the lower body by mating the screw portion of the pressure regulating valve with the lower screw portion of the lower body and further can support the lower small guide ring by letting it go higher than the pressure bearing plate.

2. A car brake anti-lock system according to claim 1, wherein a car brake anti-lock system as characterized by it that the elastic force of the said large disk springs is different from the elastic force of the small disk springs.
